(19) United States
(12) Patent Application Publication
(10) Pub. No.: US 2005/0289587 A1
(43) Pub. Date: Dec. 29, 2005

(54) METHOD AND RELATED INTERFACE SYSTEM FOR FACILITATING ADVERTISING DETECTION IN A VIDEO SIGNAL THROUGH A VISUAL INTERFACE

(76) Inventor: Andy Chiu, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 10/904,472

(22) Filed: Nov. 12, 2004

(30) Foreign Application Priority Data
Jun. 24, 2004 (TW) 093118384

(51) Int. Cl. H04N 7/025; H04N 7/10

(52) U.S. Cl. 725/34; 725/35

(57) ABSTRACT

A method and related interface system for facilitating manual detection of advertising sections within a video signal. The method includes sampling frames from every N1 frames to be reference frames in the video signal, and showing the reference frames to a user. If the user finds that a given reference frame is an advertising frame, setting N2 to be smaller than N1, sampling frames from every N2 frames between the given reference frame and its adjacent reference frame to be second layer reference frames, showing the second layer reference frames to the user such that the user can further detail selection of advertising frames, and locating advertising frames more precisely.

### BACKGROUND OF THE INVENTION

1. Field of the Invention

The invention relates to a method and related interface system for facilitating advertising section detection in a video signal, and more particularly, to a method and related interface system capable of orderly sampling/obtaining each frame in different time intervals for facilitating advertising section detection and allocation in a video signal.

2. Description of the Prior Art

Video programs provided by wired or wireless broadcasting and TV media have become an important information source in modern information society. The viewers can get useful news, knowledge, information, and entertainment from the aforementioned TV programs. However, out of business considerations, video programs often have advertising sections between normal programs. For viewers, these advertising sections interfere with normal programming and annoy viewers. When viewers want to record these programs for future viewing, these advertising sections cost a lot of the viewer's resources (for example, DVD discs or video tapes). Therefore, the advertising sections require users to inconveniently search through the recorded video signal. In the prior art, it is difficult to detect advertising sections of video signals.

### SUMMARY OF INVENTION

It is therefore a primary objective of the claimed invention to provide a method and a related interface system for users to detect advertising sections in order to further ignore or filter out the advertising sections, to solve the above-mentioned problem.

According to an exemplary embodiment of the claimed invention, a method for detecting and filtering out an advertising section from a video signal is disclosed. The method comprises: sampling frames from every first number of frames to be layer-1 reference frames in the video signal; performing a first displaying step to show the layer-1 reference frames; when a user chooses a layer-1 reference frame of the layer-1 reference frames, taking the first number of frames prior to/following the reference frame as target frames, and sampling frames every second number of the target frames as layer-2 reference frames, wherein the second number is smaller than the first number; and performing a second displaying step to show the layer-2 reference frames to the user for selecting a layer-2 reference frame of the layer-2 reference frames in order to obtain the advertising section.

In addition, an interface system for detecting and filtering out an advertising section of a video signal is disclosed, the interface system comprises: a buffering module for temporarily storing the video signal, the video signal being capable of orderly providing a plurality of frames to show a dynamic image according to a predetermined order; a processing module capable of sampling frames from every first number of frames to be layer-1 reference frames in the video signal; and a displaying interface for displaying the layer-1 reference frames, wherein when a layer-1 reference frame is selected, the processing module is capable of determining the first number of frames prior to/following the frame as target frames, and the processing module is capable of sampling frames every second number of frame as layer-2 reference frames, wherein the second number is smaller than the first number, and the displaying interface is capable of further displaying the layer-2 reference frames.

Furthermore, a method for gradually detecting and filtering out an advertising section of a video signal is disclosed, the method comprises: sampling frames every first number of frames to generate a plurality of first lessened figures from the video signal; generating a plurality of second lessened figures according to the first lessened figures selected by a user to make two adjacent second lessened figures be between a second number of frames; and obtaining and filtering out the advertising section according to the second lessened figures selected by the user; wherein the second number is smaller than the first number.

As known by those skilled in the art, the video signal can provide different frames to show a dynamic image (motion picture) in a fixed frame rate. In the present invention, different sampling times are utilized to sample/obtain frames of the video signal; in a bigger sampling time, users can substantially detect the position of the advertising section; and in a smaller sampling time, users can detect the position of the advertising section more accurately. For example, when users have to detect the position of the advertising section of a 1-hour video signal, the present invention interface system can first utilize 1 minute as the sampling time to sample the frames of video signal every 1 minute as reference frames and then lessen each reference frame for the users. Users can select a reference frame to be a frame of the advertising section. For example, if users find out that the 18^{th} reference frame (which is displayed in the 18^{th} minute) is a frame of a normal program and the 19^{th} reference frame (which is displayed in the 19^{th} minute) is a frame of the advertising section, this means that the starting position of the advertising section is between the 18^{th} minute and the 19^{th} minute. And then, the present invention interface system can utilize a smaller sampling time, 1 second, to sample frames of the video signal from the 18^{th} minute to the 19^{th} minute every one second as layer-2 reference frames. Similarly, the interface system can lessen the layer-2 reference frames for the users to detect the position of the advertising section more accurately in a second unit. For example, if users find out that the 24^{th} layer-2 reference frame is a frame of the normal program and the 25^{th} layer-2 reference frame is a frame of the advertising program, this means that the starting position of the advertising section is about 18 minutes and 24 seconds. Thereby, the position of the advertising section can be determined accurately.

In other words, the sampling time intervals are changed from big to small, and users only have to quickly browse the above-mentioned reference frames so that the users can gradually determine the position of the advertising section accurately. Therefore, the users can perform a needed operation on the advertising section, for example, an operation of filtering out, deleting, or ignoring/skipping the advertising section. The present invention interface system can be positioned in a recording/playing device (such as a video recorder/player of hardware, an optical disk, or a video tape, or a multimedia computer capable of recording/playing video signals) for users to detect the advertising section. In addition to detecting the advertising section, the present invention can be a method of quickly detecting the content of the video signal for users to detect a section having specific content accurately and quickly.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a diagram of an advertising section in a video signal.

FIG. 2 is a block diagram of an interface system of an embodiment according to the present invention.

FIG. 3 and FIG. 4 are diagrams of an operation of the interface system shown in FIG. 2.

FIG. 5 and FIG. 6 are diagrams of utilizing the displaying interface shown in FIG. 2 to detect the advertising section through the interface figures.

FIG. 7 is a diagram of cooperating the interface system shown in FIG. 2 with other automatic advertising detection mechanisms.

### DETAILED DESCRIPTION

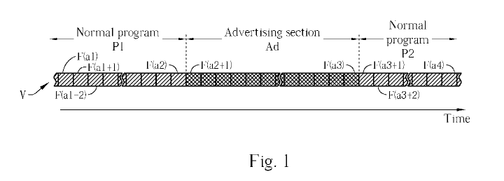

Please refer to FIG. 1, which is a diagram of a typical video signal V. The video signal V can provide different frames F(a1), F(a1+1), F(a1+2), etc. to assemble frames to show a dynamic image. As mentioned above, the video signal may have an advertising section in it. As shown in FIG. 1, frame F(a1) to frame F(a2), frame F(a3+1) to frame F(a4), etc. are respectively used to show dynamic images of normal programs P1 and P2, and frame F(a2+1) to frame F(a3) are frames of the advertising section Ad for showing the dynamic image of the advertising section.

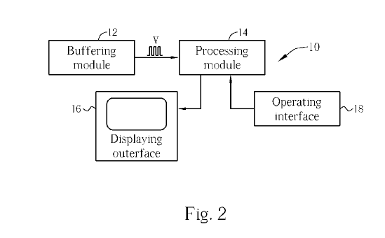

Please refer to FIG. 2, which is a block diagram of an interface system 10 of an embodiment according to the present invention. The interlace system 10 can be implemented in a video recording device or a video playing device, such as a video recorder/player utilizing video tapes, hard disks, or optical disks for users to detect the position of advertising sections. In addition, the interface system 10 can also be implemented in a multimedia computer. As shown in FIG. 2, the interface system 10 can comprise a buffering module 12, a processing module, a displaying interface 16, and an operating interface 18. When users have to detect the position of the advertising section in the video signal V, the buffering module 12 can temporarily store and provide each frame of the video signal V. The processing module 14 can utilize different sampling times to sample frames from the video signal V, which is provided by the buffering module 12, as reference frames. In the preferred embodiment of the present invention, the processing module 14 can additionally achieve a function of a lessening module to lessen the sampled reference frames to be lessened figures (i.e. thumbnails of the reference frames) Therefore, the displaying interface 16 can show the thumbnails of the reference frames to the users. The operating interface 18 can receive user's command to transform the command into an electrical signal and transfer the electrical signal to the processing module 14 in order to control the processing module 14 to change the sampling time. For example, if the interface system 10 is implemented in a video recording device, because the video recording device is utilized with a displaying device (for example, a TV) to show recorded video signals, the present invention can utilize the displaying device as the displaying interface 16 and utilize the operating interface of the video recording device as the operating interface 18. It is well-known that a normal video recording device has a remote control as the operating interface of the video recording device, therefore, the present invention interface system 10 can utilize the remote control as the operating interface 18. If the interface system 10 is implemented in a multimedia computer, the displaying interface 16 can be implemented as the display of the multimedia computer and the operating interface 18 can be implemented as the current operating interface (such as keyboard or mouse) of the multimedia computer.

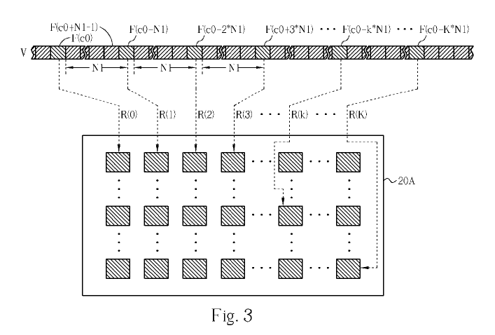

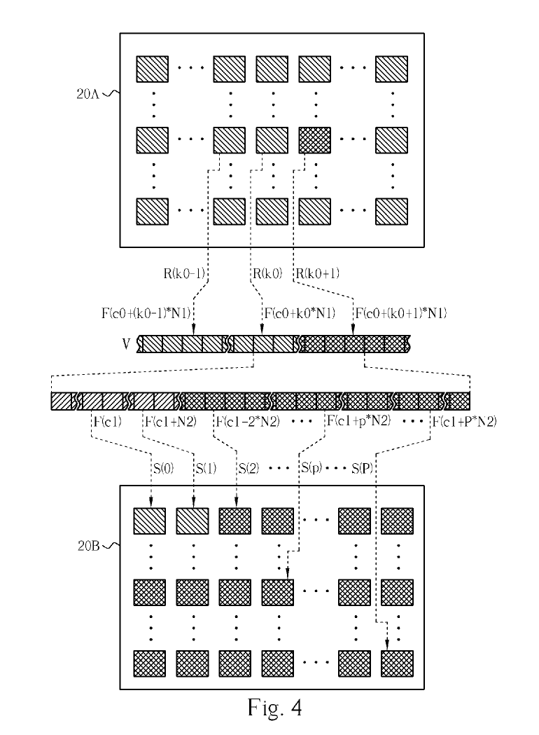

Please refer to FIG. 3 and FIG. 4 (in conjunction with FIG. 2). FIG. 3 and FIG. 4 are diagrams of operations of the interface system 10 shown in FIG. 2. First of all, when the interface system 10 starts to help users to detect the position of the advertising section from the video signal V, the processing module 14 of the interface system 10 can utilize N1 frames as a sampling time to sample frames of the video signal V. That is, the processing module 14 can sample frames of the video signal V every N1 frames as reference frames. As shown in FIG. 3, frames F(c0), F(c0+N1), F(c0+2*N1), F(c0+3*N1), . . . , F(c0+k*N1), to F(c0+K*N1), which are between N1 frames, are respectively sampled to be the reference frames R(0), R(1), R(2), R(3), . . . , R(k) to R(K), wherein c0, K, and Ni are all fixed integers. And the interface system 10 can therefore show each reference frame to the users through the displaying interface 16. In a preferred embodiment of the present invention, the content of each reference frame can be displayed on the displaying interface 16 as the above-mentioned lessened figures. As shown on the interface display 20A, this represents the display shown by the displaying interface 16 in this embodiment. As shown on the interface display 20A, the present invention can display the thumbnails of each reference frame R(0) to R(K) in a matrix so that the users can easily browse the figures and easily compare the contents of each reference frame.

Following the embodiment shown in FIG. 3, please refer to FIG. 4. After browsing and comparing the reference frames shown on interface display 20A, the users can find out which reference frame belongs to the frame of the advertising section. In the embodiment of FIG. 4, assuming the users find out that a reference frame R(k0−1) belongs to a normal program (wherein k0 is a certain value) and a next frame R(k0) is a frame of the advertising section, this means that the advertising section of the video signal V starts between the frame F(c0+(k0−1)*N1) and the frame F(c0+k0*N1). Because the reference frames R(k0−1) and R(k0) respectively correspond to the frames F(c0+(k0−1)*N1) and F(c0+k0*N1) of the video signal V, the users can control the processing module 14 through the operating interface 18 (shown in FIG. 2) so that the processing module 14 can further sample frames according to the reference frame R(k0). In the second sampling operation, the processing module 14 determines frames from the frame F(c0+(k0−1)*N1) to the frame F(c0+k0*N1) as target frames, and the processing module 14 samples the target frames every N2 frames to obtain layer-2 reference frames, wherein N2 is smaller than N1 shown in FIG. 3. In other words, in the second sampling operation, the present invention utilizes a smaller sampling interval to sample the target frames to help the users detect the position of the advertising section more accurately.

As shown in FIG. 4, frames F(c1), F(c1+N2), F(c1+2*N2), . . . , F(c1+p*N2) to F(c1+P*N2), which are between the frame F(c0+(k0−1)*N1) and the frame F(c0+k0*N1), are respectively sampled to be the layer-2 reference frames S(0), S(1), S(2), . . . , S(p), to S(P), wherein c1, P, and N2 are fixed integers. And the interface system 10 of the present invention can further display the layer-2 reference frames S(0) to S(P) through the displaying interface 16 (shown in FIG. 2) to the users. The interface display 20B shown in FIG. 4 illustrates a displaying result of lessened figures of the layer-2 reference frames on the displaying interface 16. Similarly, the users browse and compare each layer-2 reference frame S(0) to S(P) to determine the position of the advertising section more accurately. For example, if the users find out that the layer-2 reference frames S(0) and S(1) belong to the normal program but the reference frame S(2) belongs to the advertising section, this represents that the advertising section starts between the frame F(c1+N2) and the frame F(c1+2*N2) because the layer-2 reference frames S(1) and S(2) respectively correspond to the frames F(c1+N2) and F(c1+2*N2). Because N2 is smaller than N1, the users can further determine that the advertising section starts between the frame F(c1+N2) and the frame F(c1+2*N2), this represents that the present invention can utilize the second-layer interface display 20B to detect the position of the advertising section more accurately. Surely, according to similar operations and theorems, the users can determine the position of the advertising section more accurately, also.

From the illustration of FIG. 3 and FIG. 4, it can be known that the present invention utilizes a bigger sampling time(interval) N1 to detect the position (the starting frame and the finish frame) of the advertising section substantially. When the users substantially find out the position of the advertising section, the present invention can utilize a smaller sampling time(interval) N2 to further detect the position of the advertising section more accurately. Surely, following the above-mentioned operations, the present can further utilize another smaller sampling time N3 to sample frames of the video signal. Therefore, if the users find out that the starting position of the advertising section is started between the reference frame S(1) and the reference frame S(2), the present invention can utilize the smaller sampling time N3 (N3<N2<N1) to sample frames of the video signal to obtain layer-3 reference frames between the frame F(c1+N2) and the frame F(c1+2*N2) so that the users can determine the starting position of the advertising section as a certain frame between the frame F(c3) and the frame F(c3+N3). Therefore, the present invention can help the users to initially determine the advertising section in a big range (multiple frames) of the video signal, and to further accurately determine the advertising section in a smaller range (that is, the sampling rate is higher) of the video signal.

In the present invention, the sampling time can be determined according to a practical situation of a normal video signal. For example, if the advertising section is not shorter than 1 minute, and the video signal has 30 frames per second, the sampling time N1 can be determined as 60*30. That is, frames of the video signal per 1 minute are sampled as layer-1 reference frames. Because the advertising section is longer than 1 minute, if the sampling time N1 is set as 1 minute, at least one frame of the advertising section is detected as a layer-1 reference frame. And then, the layer-2 sampling time N2 in FIG. 4 can be set as 1*30. That is, between two layer-1 reference frames, 1-second time interval is utilized to sample the reference frame of the layer-2 reference frames. In other words, according to the layer-1 reference frames, the present invention can first help the users to locate the starting position of the advertising section using the precision of minutes. Furthermore, the present invention can further help the users to determine the starting position of the advertising position with the precision of seconds more accurately in the layer-2.

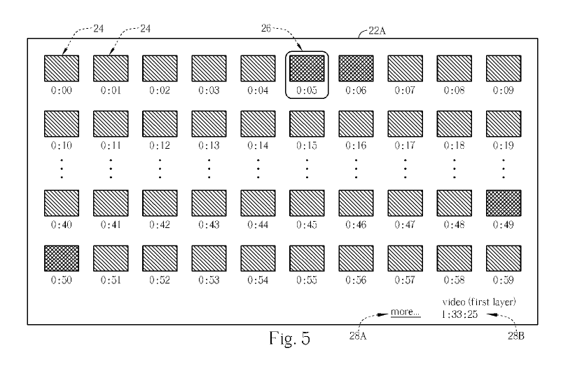

In addition, please refer to FIG. 3 and FIG. 4 again, the interface display 20A and 20B can be utilized to determine the size of lessened figures (thumbnails) and the number of reference frames that the users can browse. For example, if an interface display can contain 60 lessened figures of reference frames and the reference frames are sampled per minute in layer-1, the users can get a 60-minute video signal in a single interface display and the users can determine the starting or finishing position of the advertising section of the 60-minute video signal using the precision of minutes. For the above-mentioned operation, please refer to FIG. 5 (in conjunction with FIG. 2). The interface display 22A shown in FIG. 5 is a diagram of the displaying interface 16 (FIG. 2) in the above-mentioned operation. As shown in FIG. 5, the interface display 22A utilizes each lessened FIG. 24 to respectively show each layer-1 reference frame. And each lessened FIG. 24 has the sign for showing when the reference frame is sampled. For example, the “0:01” represents that the corresponding reference frame is sampled in the first minute of the video signal, the “0:02” represents that the corresponding reference frame is sampled in the 2^{nd} minute of the video signal, . . . and “0:59” represents that the corresponding reference frame is sampled in the 59^{th} minute of the video signal.

When the users browse the interface display 22A and determine the starting position or finishing position of the advertising section, the users can utilize the operating interface 18 to mark the above-mentioned position and to control the interface system 10 to perform another-layer reference frames sampling. In present multi-function DVD players, there has been an operating interface (such as a directional pad) having a cursor to control the DVD player. Therefore, if the present invention interface system 10 is installed in this normal video recorder, such as the above-mentioned DVD player, the users can utilize the aforementioned operating interface to achieve the function of the present invention operating interface 18. For example, in a remote control of the multi-function DVD player, there are control buttons to control the cursor to move up, down, left, and right, and there is a “enter” button to send a command. Therefore, the interface display 22A can cooperate with a cursor 26 to mark the reference frame chosen by the users. For example, when the interface display 22A shows the reference frames, the cursor 26 can be first positioned on the reference frame marked 0:00. And then, if the users find out that the reference frame marked 0:04 belongs to the normal program, but the reference frame marked 0:05 belongs to the advertising section, the users can utilize the control buttons to move the cursor 26 on the reference frame marked 0:05 and push the “enter” button. Therefore, the processing module 14 can determine the frame marked 0:04 and the frame marked 0:05 as target frames to perform layer-2 reference frames sampling. Absolutely, if the present invention system is utilized in a multimedia computer, because the computer has a lot of operating interfaces, such as a keyboard, a mouse, a touch pad, or a track ball, all these aforementioned devices can be utilized to achieve the function of the operating interface 18.

In addition to the layer-1 reference frame (regarded as the first reference frame), the interface display 22A can present other commands or states. For example, if the video signal is longer than 1 hour and the sampling time is 1 minute, one interface display can only present 1-hour reference frames. Here, the interface display 22A can show a command list 28A (for example, a word “more” or the words “next page”). When the users control the cursor 26 on the command list 28 and push the “enter” button, the interface system 10 can sample the other part of the video signal to obtain other reference frames. Furthermore, the interface display 22A can show other information, such as total play time of the video signal or the currently proceeding state of the advertising section detection.

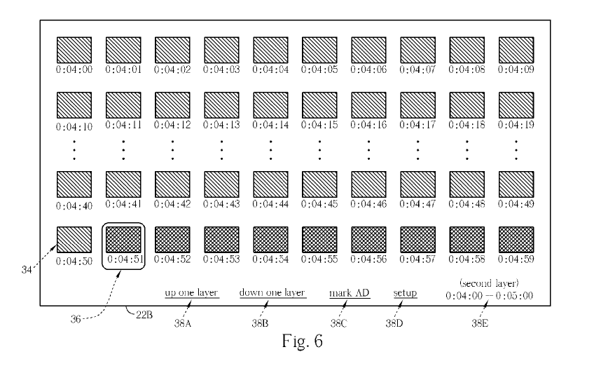

Following the embodiment in FIG. 5, please refer to FIG. 6. After the users select the reference frame marked 0:05 and control the interface system 10 to perform the layer-2 reference frames sampling, the display interface 16 utilizes the interface display 22B to display the layer-2 reference frames. In the embodiment in FIG. 5, assuming that a display can contain 60 lessened figures of reference frames, the interface system 10 can sample the video signal between the 4^{th} minute and the 5^{th} minute per second in the operation of layer-2 reference frames sampling for generating the layer-2 reference frames (or the second reference frames). Furthermore, the layer-2 reference frames are presented through the lessened FIGS. 34. Similarly, each lessened figure of each reference frame can have a mark to show the sampling timing. For example, the mark 0:04:01; represents that the corresponding reference frame is a frame of the 4^{th} minute and the 1^{st} second of the video signal, and the mark 0:04:51 represents that the corresponding reference frame is a frame of the 4^{th} minute and the 51^{st} frame, . . . , etc.

And then the users compare each layer-2 reference frame to accurately determine the advertising section in the unit of seconds. Similarly, the interface display 24B can display a cursor 36 to show the layer-2 reference frame selected by the users. For example, if the users find out that the reference frame marked 0:04:50 belongs to the normal program, and the reference frame marked 0:04:51 belongs to the advertising section, this represents that the advertising section starts between the 4^{th} minute and the 50^{th} second and the 4^{th} minute and the 51^{st} second of the video signal. Therefore, the users can utilize the cursor 36 to select the reference frame marked 0:04:51 and the interface system 10 (shown in FIG. 2) can perform the corresponding operation. Similar to the interface display 24A shown in FIG. 5, the interface display 24B can also display multiple instruction lists 38A-38D and a state list 38E. For example, if the users move the cursor 36 on the reference frame marked 0:04:51, the users can push the “enter” button to select the reference frame, and if the users think that it is accurate enough to determine the advertising section in a unit of seconds, the users can move the cursor 36 on the instruction list 38C (which can show the words “mark AD”) and push the “enter” button to trigger the certain instruction so that the interface system 10 can cooperate with a temporarily storing module (not shown in FIG. 2) to mark and store the reference frame marked 0:04:51 as a starting position of an advertising section. Therefore, the users can utilize the record stored in the temporarily storing module to ignore, skip or delete the advertising section.

Oppositely, after the users select the layer-2 reference frame marked 0:04:51, the users want to determine the advertising section more accurately. The users can trigger the instruction list 38B (which can show the words “down one layer”), and the interface system 10 utilizes the frames between the 4^{th} minute and 50^{th} second and the 4^{th} minute and the 51^{st} second as layer-3 target frames. That is, the interface system 10 utilizes a sampling time, which is shorter than 1 second, to perform the layer-3 reference frames sampling for helping users to more accurately determine the advertising section. Surely, the users can also trigger the instruction list 38A (which can show the words “up one layer”), and the interface system 10 showing the interface display 24A shown in FIG. 5 again so that the users can browse the layer-1 reference frames again. Furthermore, the users can trigger the instruction list 38D (which can show “setup”) to perform the corresponding settings of the interface system 10. For example, number of reference frames shown in an interface display can be set, or a size of the lessened figures of the reference frames can be set. Regardless of the interface display in FIG. 5 or FIG. 6, the interface display can also have the instruction list 38D. The instruction list 38C of the interface display 24B can further show the state of detecting the advertising section, for example, the interface display 24B can show “second layer” to inform the users that the advertising section detection is performed in layer-2.

In addition to showing different-layer reference frames to help the users to determine the advertising section, the present invention interface system 10 (shown in FIG. 2) can cooperate with other automatic detecting advertising section mechanisms. For example, because the contents of the advertising section and the normal program are quite different, the transition between the advertising section and the normal program has a discontinuity of contents. Taking the embodiment of FIG. 1 for example, the advertising section causes a discontinuity between the frame F(a2) and the frame F(a2+1). Similarly, a discontinuity occurs between the frame F(a3) and the frame F(a3+1). Therefore, the advertising section detection may be completed through detecting the discontinuity of the video signal. However, the discontinuity may occur in the transition of the normal program. Therefore, the discontinuity is only a “possible” inserting position of the advertising section, and whether the discontinuity is a real inserting position of the advertising section or not has to be determined by other operations. For example, the users can compare the frame of the inserting position with other frames. At this time, the interface system 10 can cooperate with it to utilize the display interface 16 to show the frames of the possible inserting position of the advertising section to the users so that the users can utilize these frames to determine the real inserting position of the advertising section.

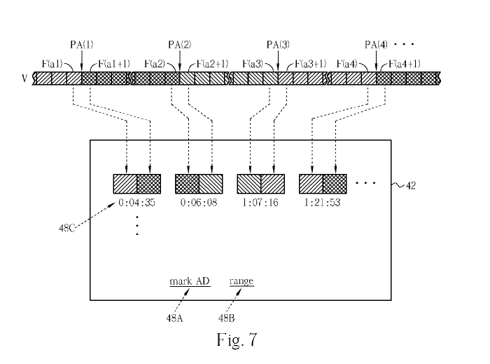

Please refer to FIG. 7 (in conjunction with FIG. 2), wherein FIG. 7 is a diagram of cooperating the interface system 10 shown in FIG. 2 with other automatic advertising detection mechanisms. Assuming that an automatic advertising section detection mechanism (this can be the above-mentioned discontinuity detection mechanism or other detection mechanisms) has detected a plurality of possible inserting positions PA (1)-PA(4) of the advertising section in the video signal V, the present invention interface system 10 (shown in FIG. 2) can sample the frames near the possible inserting position of the advertising section as the reference frames and utilize the display interface 16 to lessen the reference frames in order to show the lessened figures to the users. The interface display 42 shown in FIG. 7 is utilized to show the lessened figures of the reference frames to the users in this above-mentioned embodiment of the display interface 16. Here, the possible inserting position PA(a) of the advertising section corresponds to two successive frames F(a1) and F(a1+1), therefore, these two frames are used as the reference frames and lessened to be shown to the users. Similarly, the possible inserting positions PA(2), PA(3), and PA(4) of the advertising section respectively correspond to the successive frames F(a2) and F(a2+1), frames F(a3) and F(a3+1), and frames F(a4) and F(a4+1), and these frames can be also lessened to be shown to the users.

After browsing two successive frames, the users can determine whether the corresponding possible inserting position is the real inserting position of the advertising section. For example, if frames F(a1) and F(a1+1) belong to the normal program, this means that the inserting position PA(1) may not be the real inserting position of the advertising section. Oppositely, if the frame F(a2) belongs to the normal program but the frame F(a2+1) belongs to the advertising section, this represents that the possible inserting position PA(2) is indeed the inserting position of the advertising section. Therefore, the users can utilize the operating interface 18 to select the possible inserting position PA(2) and trigger the instruction list 48A of the interface display 42 to ensure that this possible inserting position PA(2) is the real inserting position of the advertising section. Surely, the interface display 42 can further display other instruction lists of other functions for users to perform other operations. For example, after the users trigger the instruction list 48B, the users can sample more frames near the possible inserting position as the reference frames, such as the F(a1−1), F(a1), F(a1+1), and F(a1+2) so that the users can determine whether the possible inserting position PA(1) is the real inserting position of the advertising section more easily. Furthermore, the interface display 42 can utilize the state list to show other related information, for example, the state list 48C is utilized to show the timing of the video signal V corresponding to the possible inserting position PA(1).

To sum up, the present invention can display different-layer reference frames through the interface display of the display interface to help the users to quickly and accurately determine the position of the advertising section. In initial-layer reference frames, the present invention can help the users to quickly browse a large range of video signals and to determine the position of the advertising section initially. And in following-layer reference frames, the present invention can further help the users to accurately determine the position of the advertising section. Surely, the aforementioned operation according to the present invention can also help the users to quickly and accurately determine a section of specific content in a big range of the video signal. Furthermore, the present invention can cooperate with the automatic advertising section detection mechanisms. In contrast to the prior art, the present invention can help the users to determine the position of the advertising section more easily such that the users can easily ignore or delete the advertising section and the users can utilize the useful information of the video signal more efficiently.

Those skilled in the art will readily observe that numerous modifications and alterations of the device and method may be made while retaining the teachings of the invention. Accordingly, the above disclosure should be construed as limited only by the metes and bounds of the appended claims.

1. A method for detecting and filtering out an advertising section from a video signal comprising:
sampling frames from the video signal using a first number of frames as layer-1 reference frames;
performing a first displaying step to show the layer-1 reference frames;
when a user chooses a layer-1 reference frame of the layer-1 reference frames, taking the first number of frames prior to/following the reference frame as target frames, and sampling frames every second number of the target frames as layer-2 reference frames, wherein the second number is smaller than the first number; and
performing a second displaying step to show the layer-2 reference frames to the user for selecting a layer-2 reference frame of the layer-2 reference frames in order to obtain the advertising section.

2. The method of claim 1, wherein the step of performing the first displaying step comprises:
lessening an image of each first frame into a corresponding lessened figure; and
displaying the corresponding lessened figure.

3. The method of claim 1, wherein the step of performing the second displaying step comprises:
lessening an image of each second frame into a corresponding lessened figure; and
displaying the corresponding lessened figure.

4. The method of claim 1 further comprising:
obtaining the video signal, wherein the video signal is capable of providing a plurality of frames according to a predetermined order to show a dynamic image.

5. The method of claim 1 further comprising:
providing an operating interface to allow the user to choose the layer-1 reference frames and the second frames.

6. An interface system for detecting and filtering out an advertising section of a video signal, the interface system comprising:
a buffering module for temporarily storing the video signal, the video signal being capable of orderly providing a plurality of frames to show a dynamic image according to a predetermined order;
a processing module capable of sampling frames from every first number of frames to be layer-1 reference frames in the video signal; and
a displaying interface for displaying the layer-1 reference frames, wherein when a layer-1 reference frame is selected, the processing module is capable of determining the first number of frames prior to/following the frame as target frames, and the processing module is capable of sampling frames every second number of frame as layer-2 reference frames, wherein the second number is smaller than the first number, and the displaying interface is capable of further displaying the layer-2 reference frames.

7. The interface system of claim 6 further comprising:
a lessening module for lessening an image of each layer-1 reference frame into a corresponding lessened figure, wherein when the displaying interface displays the layer-1 reference frames, the displaying interface simultaneously displays the corresponding lessened figure.

8. The interface system of claim 7, wherein the lessening module further lessens the layer-2 reference frames into another corresponding lessened figure, and when the displaying interface displays the layer-2 reference frames, the displaying interface simultaneously displays the other corresponding lessened figure.

9. The interface system of claim 6 further comprising:
an operating interface for allowing the user to choose the layer-1 reference frames and the layer-2 reference frames in order to allow the processing module to generate the target frames.

10. A method for gradually detecting and filtering out an advertising section of a video signal, the method comprising:
sampling frames every first number of frames to generate a plurality of first lessened figures from the video signal;
generating a plurality of second lessened figures according to the first lessened figures selected by a user to make two adjacent second lessened figures be between a second number of frames; and
obtaining and filtering out the advertising section according to the second lessened figures selected by the user;
wherein the second number is smaller than the first number.

11. The method of claim 10 further comprising:
setting a range between a first lessened figure selected by the user and another first lessened figure prior to the first lessened figure to be a target frame range; and
sampling frames every second number of frames in the target frame range as the layer-2 reference frames.

12. The method of claim 10 further comprising:
setting a range between a first lessened figure selected by the user and another first lessened figure following the first lessened figure to be a target frame range; and
sampling frames every second number of frames in the target frame range as the layer-2 reference frames.

13. The method of claim 10 further comprising:
providing an operating interface to the user to select the first lessened figures and the second lessened figures, wherein the first lessened figures and the second lessened figures are all displayed in a displaying interface.

14. The method of claim 10 further comprising:
generating a plurality of third lessened figures according to the second lessened figures selected by the user to make every two adjacent figures be between a third number of frames; and
obtaining and filtering out the advertising section according to the third lessened figures selected by the user;
wherein the third number is smaller than the second number.
